(19) United States
(12) Patent Application Publication
(10) Pub. No.: US 2024/0411586 A1
(43) Pub. Date: Dec. 12, 2024

(54) DYNAMIC REQUEST MODE USING SMART REQUEST SYSTEM

(71) Applicant: SAP SE, Walldorf (DE)

(72) Inventor: Xinrong Huang, Shanghai (CN)

(21) Appl. No.: 18/206,950

(22) Filed: Jun. 7, 2023

(51) Int. Cl. G06F 9/48; G06F 16/27

(52) U.S. Cl. CPC G06F 9/4881; G06F 16/27

(57) ABSTRACT

A first service of a microservices architecture may obtain a set of one or more metrics of the microservices architecture. The microservices architecture may include the first service, a second service, and a network, where the first and second services are configured to communicate with each other via the network. The first service may determine that the set of metrics satisfies one or more bulk mode conditions. The first service may identify a plurality of workers of the first service running in parallel to one another, where each worker is configured to execute a task. The first service may send a bulk request to the second service based on the determining that the set of metrics satisfies the one or more bulk mode conditions. The bulk request may comprise a corresponding request body portion for each worker in the plurality of workers.

### BACKGROUND

A microservices architecture is an architectural style that arranges an application as a collection of loosely coupled, fine-grained services, communicating through lightweight protocols. Services in a microservice architecture are often processes that communicate over a network to fulfill a goal. The microservices architecture breaks a large and complex system into smaller, independent, and loosely coupled parts, thereby improving fault isolation and scalability.

In a microservices architecture, each service may provide a set of representational state transfer (RESTful) application programming interfaces (API's) to communicate with other services. The use of REST provides simplicity, flexibility, and scalability. However, the communication between services may be complex. The performance of communication between services in a microservices-based system may create a bottleneck for the overall performance of the system. Current microservices architectures send requests using a single request mode in which a single request is sent at a time. With the increase in body size of requests, network latency, and data loss rate over a network, as well as other technical issues, using the single request mode approach results in an extremely large overhead on sending requests, thereby dramatically impacting the overall performance of the microservices-based system. Other technical challenges may arise as well.

### BRIEF DESCRIPTION OF THE DRAWINGS

Some example embodiments of the present disclosure are illustrated by way of example and not limitation in the figures of the accompanying drawings, in which like reference numbers indicate similar elements.

FIG. 1 is an example network diagram illustrating a system.

FIG. 2 is a block diagram illustrating an example smart request system.

FIG. 3 is a block diagram illustrating a bulk request manager being used to implement a bulk request mode.

FIG. 4 is a flowchart illustrating an example method of implementing a dynamic request mode using a smart request system.

FIG. 5 is a flowchart illustrating an example method of implementing a bulk GET request.

FIG. 6 is a flowchart illustrating an example method of implementing a bulk POST request.

FIG. 7 is a block diagram of an example computer system on which methodologies described herein can be executed.

### DETAILED DESCRIPTION

Example methods and systems of implementing a dynamic request mode using a smart request system are disclosed. In the following description, for purposes of explanation, numerous specific details are set forth in order to provide a thorough understanding of example embodiments. It will be evident, however, to one skilled in the art that the present embodiments can be practiced without these specific details.

The implementation of the features disclosed herein involves a non-generic, unconventional, and non-routine operation or combination of operations. By applying one or more of the solutions disclosed herein, some technical effects of the system and method of the present disclosure are to implement dynamic request mode using a smart request system. The smart request system may be configured to dynamically and intelligently send requests in bulk request mode or single request mode in real-time based on one or more technical factors of a microservices architecture, such as number of running workers, central processing unit (CPU) usage, network latency, bandwidth, and packet loss rate. In some example embodiments, a first service of a microservices architecture implemented by a computer system may obtain a first set of one or more metrics of the microservices architecture. The microservices architecture may include the first service, a second service, and a network, where the first service and the second service are configured to communicate with each other via the network. The first service may determine that the first set of one or more metrics satisfies one or more bulk mode conditions. The first service may identify a plurality of workers of the first service running in parallel to one another, where each one of the plurality of workers is configured to execute a task. The first service may then send a bulk request to the second service based on the determining that the first set of one or more metrics satisfies the one or more bulk mode conditions. The bulk request may comprise a corresponding request body portion for each worker in the plurality of workers.

By dynamically and intelligently sending requests in bulk request mode or single request mode based on one or more technical factors of a microservices architecture, the smart request system of the present disclosure reduces the number of communications between services in the microservices architecture, thereby making the microservice architecture more efficient and improving its overall performance. Other technical effects will be apparent from this disclosure as well.

The methods or embodiments disclosed herein may be implemented as a computer system having one or more modules (e.g., hardware modules or software modules). Such modules may be executed by one or more hardware processors of the computer system. In some example embodiments, a non-transitory machine-readable storage device can store a set of instructions that, when executed by at least one processor, causes the at least one processor to perform the operations and method steps discussed within the present disclosure.

The details of one or more variations of the subject matter described herein are set forth in the accompanying drawings and the description below. Other features and benefits of the subject matter described herein will be apparent from the description and drawings, and from the claims.

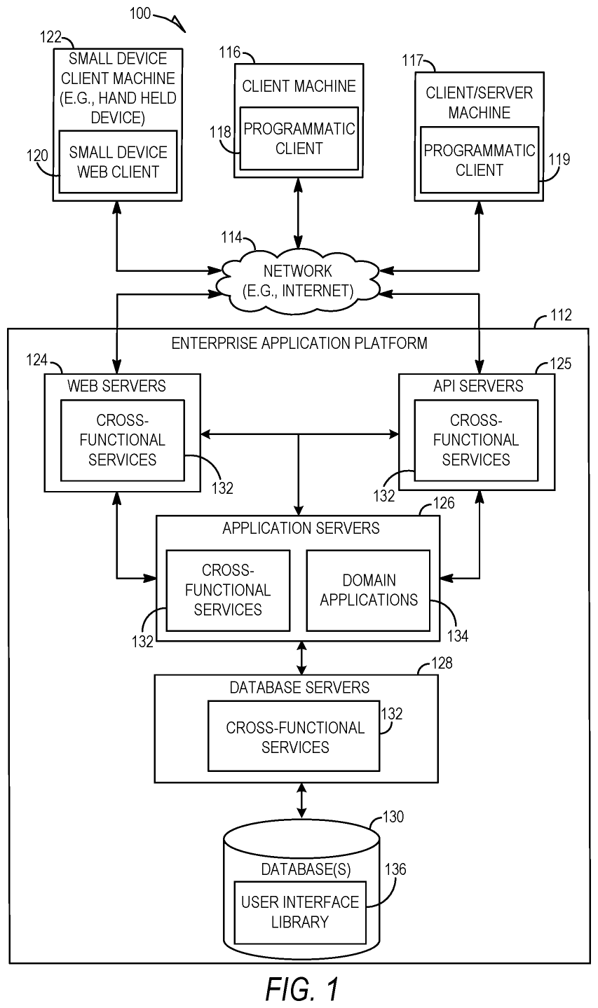

FIG. 1 is an example network diagram illustrating a system 100. A platform (e.g., machines and software), in the example form of an enterprise application platform 112, provides server-side functionality, via a network 114 (e.g., the Internet) to one or more clients. FIG. 1 illustrates, for example, a client machine 116 with programmatic client 118 (e.g., a browser), a small device client machine 122 with a small device web client 120 (e.g., a browser without a script engine), and a client/server machine 117 with a programmatic client 119.

Turning specifically to the enterprise application platform 112, web servers 124 and Application Program Interface (API) servers 125 can be coupled to, and provide web and programmatic interfaces to, application servers 126. The application servers 126 can be, in turn, coupled to one or more database servers 128 that facilitate access to one or more databases 130. The web servers 124, API servers 125, application servers 126, and database servers 128 can host cross-functional services 132. The cross-functional services 132 can include relational database modules to provide support services for access to the database(s) 130, which includes a user interface library 136. The application servers 126 can further host domain applications 134. The web servers 124 and the API servers 125 may be combined.

The cross-functional services 132 provide services to users and processes that utilize the enterprise application platform 112. For instance, the cross-functional services 132 can provide portal services (e.g., web services), database services, and connectivity to the domain applications 134 for users that operate the client machine 116, the client/server machine 117, and the small device client machine 122. In addition, the cross-functional services 132 can provide an environment for delivering enhancements to existing applications and for integrating third-party and legacy applications with existing cross-functional services 132 and domain applications 134. In some example embodiments, the system 100 comprises a client-server system that employs a client-server architecture, as shown in FIG. 1. However, the embodiments of the present disclosure are, of course, not limited to a client-server architecture, and could equally well find application in a distributed, or peer-to-peer, architecture system.

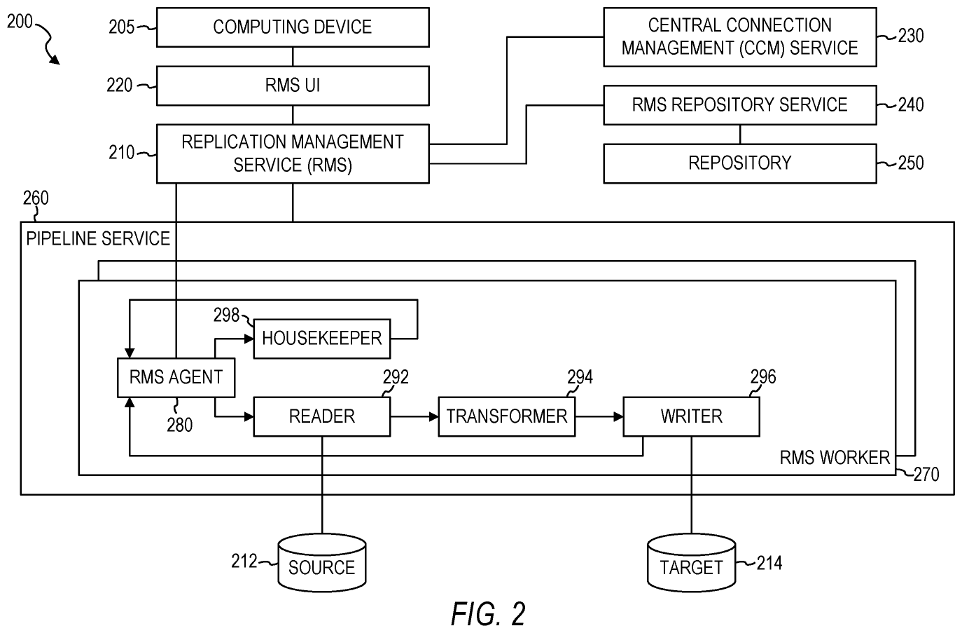

FIG. 2 is a block diagram illustrating an example smart request system 200. The components shown in FIG. 2 may be configured to communicate with each other via one or more network connections, such as via the network 114 in FIG. 1. In some example embodiments, one or more of the components of the smart request system 200 may be implemented by the enterprise application platform 112 of FIG. 1. However, the smart request system 200 may be implemented in other ways as well. The smart request system 200 may comprise a replication management service (RMS) 210. The RMS 210 may provide data replication service as a microservice and communicate with other microservices in a cloud-based data management service. Data replication is the process of making one or more additional copies of data and storing the same data in multiple locations, such as on multiple storage devices. The RMS 210 may be configured to perform a replication task that copies data from a source system 212 (e.g., in a source database) and stores the copied data on a target system 214 (e.g., in a target database). Users may use their computing device 205 to interact with the RMS 210 via an RMS user interface (UI) 220. The RMS 210 may communicate with other services, such as a central connection Management (CCM) service 230 and an RMS repository service 240 that provides repository tools that enable a user to browse a hierarchy of design-time objects stored in a repository 250.

The RMS 210 may manage replication task definitions, such as connection identifications for the source system 212 and the target system 214, as well as a source table metadata. A replication task may be divided into multiple subtasks, also referred to as work orders. These work orders may include a setup task that checks the validity of artifacts of a replication task in the source system 212 and the target system 214, a partition task that divides the whole dataset to be replicated into partitions that are to be independently executed and can be scheduled in parallel, a transfer task that schedules transfer of data per partition and monitors the progress of the scheduled transfer, and a cleanup task that cleans up computer disk storage.

Setup, partition, and cleanup tasks may be treated as housekeeper work orders, whereas transfer tasks may perform the actual data replication from the source system 212 to the target system 214. Replication work orders are runnable tasks that can be scheduled by the RMS 210. The smart request system 200 may comprise a pipeline service 260 that controls the execution of RMS workers 270, which are also referred to as graphs. Each RMS worker 270 may be configured to execute a replication task to perform data replication its related subtasks, such as auto-partitioning, change data capture (CDC) replication, and housekeeping. The pipeline service 260 may control the execution of the RMS workers 270. Each RMS worker 270 may comprise a sequence of computing processes (e.g., commands, program runs, tasks, threads, procedures, etc.), in which the output stream of one process is automatically fed as the input stream of the next process in the sequence. Work orders may be assigned to RMS workers 270 to run in the pipeline service 260. In each phase of a replication task, one or more work orders may be generated to run.

The RMS 210 may orchestrate tasks of the RMS workers 270 and manage the replication task lifecycle. The RMS repository service 240 may comprise a central repository that stores both replication task definitions (e.g., design-time data) and replication worker task states (e.g., run-time data), which may be accessed and used by the RMS 210 to orchestrate the tasks of the RMS workers 270. The CCM service 230 may provide a central directory for connection information and credentials that may be used by the RMS 210 to connect and communicate with the pipeline service 260 and other components of the smart request system 200.

Each RMS worker 270 may comprise one or more operators. An operator may comprise a reactive component that reacts to events from its environment, such as to actions of other components in its environment. The operators of the RMS worker 270 may comprise an RMS agent 280, a housekeeper 298, a reader 292, a transformer 294, and a writer 296. The RMS agent 280 may be configured to communicate with the RMS 210. For example, the RMS agent 280 may send requests to get work orders from the RMS 210 and post the work order status to the RMS 210 after work orders are processed by the operators in the RMS worker 270. The RMS agent 280 may send housekeeping work orders to the housekeeper 298. The housekeeper 298 may be configured to handle housekeeping work orders, such as setup, partitioning, and cleanup workorders. The housekeeper 298 may also send back the work order status to RMS agent 280. The RMS agent 280 may also send transfer or replication work orders to the reader 292. The reader 292 may be configured to read data from a data source, such as from the source system 212, and then send the data to the transformer 294. The transformer 294 may be configured to performs transformation on the data received from the reader 292, such as conversion of data types. The transformed data may then be sent to the writer 296, which may be configured to write the data to the target system 214 and send the work order status back to RMS agent 280.

A work order of the RMS 210 may define metadata for the replication of data from the source system 212 to the target system 214 such as source and target data connection information and schema. Data may be read from the source system 212 by the reader 292 when it receives the work order. The data may be stored in the payload of a message and forwarded to the next operator in RMS worker. The data may be written to the target system 214 by the writer 296. A work order status may be issued and updated by each operator once completing the work order, and the work order status may be sent back to the RMS agent 280. In order to improve replication efficiency over a network, the smart request system 200 may divide a replication data set into partitions. Each partition may be further divided into delimitations. For example, a replication task may replicate a data set containing 1 million records with a size of 1 GB from the source system 212 to the target system 214. If the data set is divided into 10 partitions, 10 delimitations per partition, and each record size is 1 KB, the delimitation and partition states may be as follows: Partitions=10, Partition Size=100 MB, Records Per Partition=100000 rows; Delimitations=100, Delimitation Size=1 MB, Records Per Delimitation=1000 rows. In this example, if not considering failed work orders, there may be 1000 work orders for the replication task, with one work order per delimitation.

The pipeline service 260 may start and run multiple RMS workers 270 to handle replication work orders based on workloads. As previously mentioned, each RMS worker 270 may comprise an RMS agent 280 that is responsible for communication with the RMS 210 to get work orders and post work order status. The RMS 210 may provide two RESTful API's for the RMS agent 280. The first API may be configured to be used by the RMS agent 280 to send a GET request to get work orders from the RMS 210 to process. The second API may be configured to be used by the RMS agent 280 to send a POST request to post work order status to the RMS 210 after the work order has been processed by the RMS worker 270.

The smart requests system 200 may be configured to dynamically change between two modes of sending requests, single request mode and bulk request mode. Single request mode is simple and convenient, sending a single request, such as a single HTTP request, at a time. In contrast to single request mode, bulk request mode sends multiple requests within a single request, such as within a single HTTP request, to achieve better performance, providing applications and services with the ability to make requests with higher throughput. The bulk request mode also increases performance of operations running over high latency connections. In the smart request system 200, multiple RMS workers 270 may be running in parallel and each RMS worker 270 may send single requests to communicate with the RMS 210 independently.

With increasing request body size, network latency, and data loss rate over a network, as well as other technical challenges, the use of the single request mode encounters much higher overhead on HTTP requests, thereby dramatically impacting the overall performance of the smart request system 200. The smart request system 200 may use the bulk request mode to improve overall performance by reducing communications between the RMS 210 and the RMS agent 280. The smart requests system 200 may also be configured to switch between single request mode and bulk request mode dynamically and intelligently in real time based on an evaluation of factors, such as a total number of running RMS workers 270, CPU usage, net latency, size of request body, bandwidth, and packet loss rate.

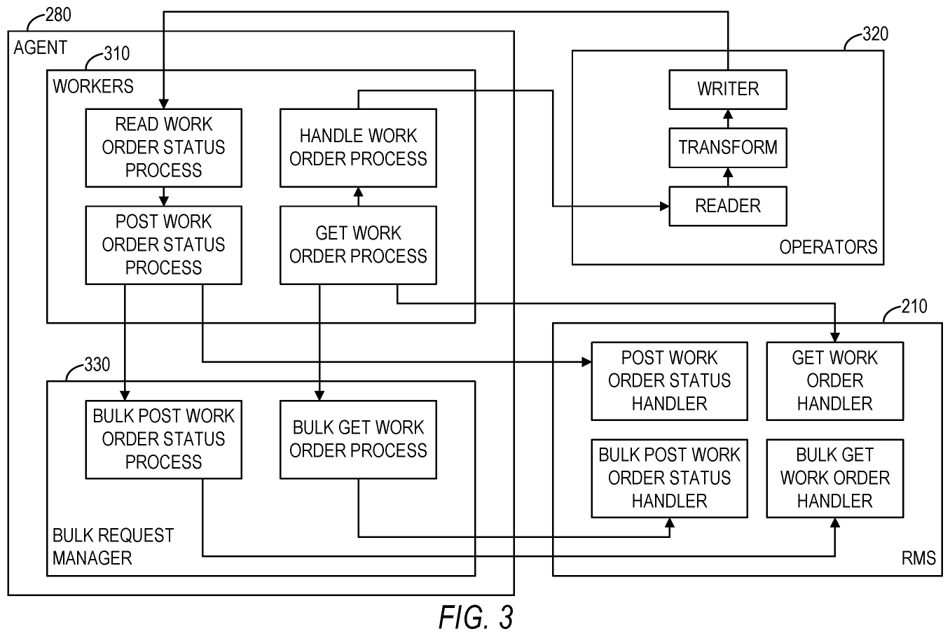

FIG. 3 is a block diagram illustrating the RMS agent 280 using a bulk request manager 330 to implement a bulk request mode. The RMS agent 280 may comprise a plurality of agent workers 310 that may run in parallel to communicate with the RMS 210. Each agent worker 310 may run independently in the RMS agent 280 and listen to an in-port of an operator 320 and an out-port of an operator 320. In FIG. 3, four processes may be running for each agent worker 310 in the agent 280: a get work order process that is responsible for sending GET requests to get work orders from the RMS 210, a handle work order process that is responsible for dispatching work orders to the next operator 320 (e.g., to the reader), a read work order status process that is responsible for watching for incoming work order status from the writer, and a post work order status process that is responsible for sending POST requests to post work order status to the RMS 210. In the get work order process, the agent worker 310 may be configured to send a single HTTP request to get a work order if it is free. In the post work order status process, the agent worker 310 may be configured to send a single HTTP request to post the work order status in response to receiving the work order status from the writer. The RMS 210 may comprise a get work order handler that handles the GET requests from the agent worker 310 to get a work order and a post work order status handler that handles to handle the POST requests from the agent worker 310 to post a work order status.

The RMS agent 280 may use the bulk request manager 330 to manage bulk HTTP requests. For example, the bulk request manager 330 may start a bulk get work order process to send bulk GET requests to get a work order if the agent worker 310 is free and a bulk post work order status process to post the work order status once received from the writer. The RMS 210 may provide a bulk get work order handler and a bulk post work order status handler to handle bulk requests. In the single request mode, the agent workers 310 may send requests directly to the RMS 210. However, in bulk request mode, the agent workers 310 may store requests in a buffer, and the bulk request manager 330 may check the buffer and send the multiple requests stored in the buffer to the RMS 210 using a single request.

The smart request system 200 may be configured to consider one or more factors in order to make a decision on what request mode, single request mode or bulk request mode, to use. The factors may include metrics of the microservices architecture in which the RMS 210 is running. These metrics may include, but are not limited to, a total number of agent workers 310, a central processing unit (CPU) usage value, a network latency metric, a bandwidth metric, and a packet loss metric. Other types of metrics are also within the scope of the present disclosure. In one example, the smart request system 200 turns on bulk request mode if one of the following conditions is satisfied: the number of running workers is greater than 10, the CPU usage is higher than 60%, the latency is greater than 100 milliseconds, the bandwidth is less than 100 Mbps, or the packet loss rate is greater than 30%. Other conditions are also within the scope of the present disclosure.

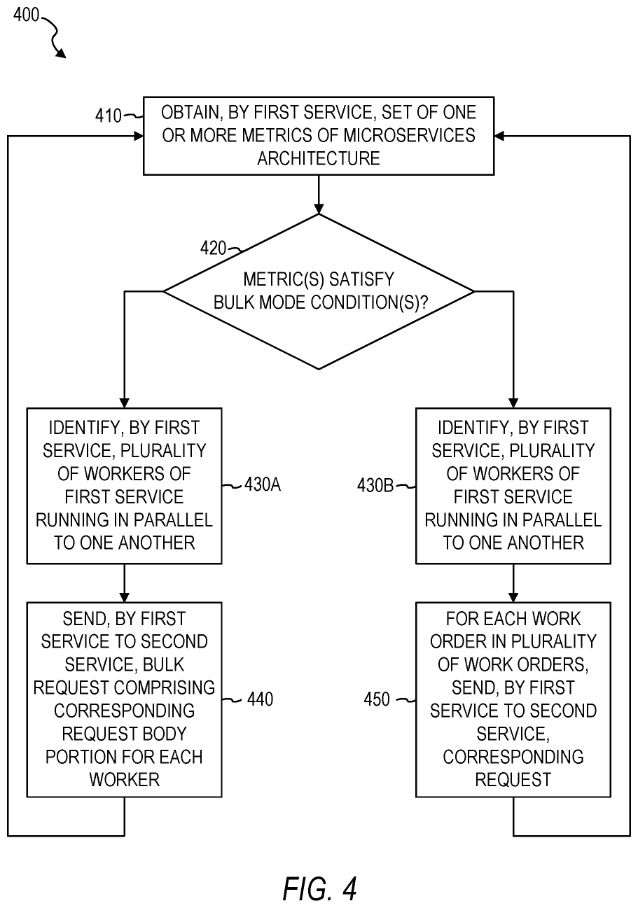

FIG. 4 is a flowchart illustrating an example method 400 of implementing a dynamic request mode using a smart request system. The method 400 can be performed by processing logic that can comprise hardware (e.g., circuitry, dedicated logic, programmable logic, microcode, etc.), software (e.g., instructions run on a processing device), or a combination thereof. In one example embodiment, one or more of the operations of the method 400 are performed by the smart request system 200 of FIG. 2 or any combination of one or more of its components.

At operation 410, a first service of a microservices architecture may obtain a set of one or more metrics of the microservices architecture. The first service may comprise the pipeline service 260 in FIG. 2. However, the first service may comprise other services. The microservices architecture may include the first service, a second service, and a network. The second service may comprise the RMS 210 in FIG. 2. However, the second service may comprise other services. The first service and the second service may be configured to communicate with each other via the network. In some example embodiments, the set of one or more metrics may comprise one or more metrics from a group of metrics consisting of a total number of workers running in the first service, a central processing unit (CPU) usage value of the second service, a network latency metric of the network, a bandwidth metric of the network, and a packet loss metric of the network. The set of one or more metrics may comprise two or more metrics from the above-mentioned group of metrics. Other metrics are also within the scope of the present disclosure.

Next, the first service may determine whether the set of one or more metrics satisfies one or more bulk mode conditions, at operation 420. In some example embodiments in which the set of one or more metrics comprises a total number of workers running in the first service, the one or more bulk mode conditions may comprise the total number of workers being greater than a threshold number. In some example embodiments in which the set of one or more metrics comprises a central processing unit (CPU) usage value of the second service, the one or more bulk mode conditions may comprise the CPU usage value of the second service being greater than a threshold usage value. In some example embodiments in which the set of one or more metrics comprises a network latency metric of the network, the one or more bulk mode conditions may comprise the network latency metric being greater than a threshold latency value. In some example embodiments in which the set of one or more metrics comprises a bandwidth metric of the network, the one or more bulk mode conditions may comprise the bandwidth metric being less than a threshold bandwidth value. In some example embodiments in which the set of one or more metrics comprises a packet loss metric of the network, the one or more bulk mode conditions may comprise the packet loss metric being greater than a threshold packet loss value.

If the first service determines, at operation 420, that the set of one or more metrics satisfies one or more bulk mode conditions, then the first service may, at operation 430A, identify a plurality of workers of the first service running in parallel to one another. Each one of the plurality of workers may be configured to execute a task. The task may comprise a data replication task. However, other types of tasks are also within the scope of the present disclosure.

After identifying the plurality of workers at operation, 430A, the first service may then, at operation 440, send a bulk request to the second service based on the determination at operation 420 that the set of one or more metrics satisfies the one or more bulk mode conditions. The bulk request may comprise a corresponding request body portion for each worker in the plurality of workers. In some example embodiments, the bulk request comprises a Hypertext Transfer Protocol (HTTP) request. However, other types of requests are also within the scope of the present disclosure.

If the first service determines, at operation 420, that the set of one or more metrics does not satisfy the one or more bulk mode conditions, then the first service may, at operation 430B, identify a plurality of workers, as in operation 430A. After identifying the plurality of workers at operation, 430B, the first service may then, at operation 450, for each worker in the plurality of workers, send a corresponding request to the second service based on the determination at operation 420 that the set of one or more metrics does not satisfy the one or more bulk mode conditions. Each corresponding request may comprise an HTTP request. However, other types of requests are also within the scope of the present disclosure. After the sending of the bulk request at operation 440 or the sending of corresponding requests at operation 450, the method 400 may repeat by returning to operation 410, where the first service may obtain another set of one or more metrics of the microservices architecture at a point in time that is later than the time at which the set of one or more metrics were previously obtained. For example, the first service may repeatedly obtain a new set of the one or more metrics at one-minute intervals. Other intervals, schedules, and triggers for obtaining the new set of the one or more metrics may be used as well.

It is contemplated that any of the other features described within the present disclosure can be incorporated into the method 400.

A Bulk GET request may comprise an HTTP POST request in which the HTTP POST request body contains a list of agent workers 310 that are currently free to take work orders. One example of a bulk GET request to get work orders for three workers that are free is shown below:

```
{
  “BulkGetRequestOrder”: {
    “Worker1”: “FREE”.
    “Worker2”: “FREE”.
    “Worker3”: “FREE”
  }
}
```

One example of a bulk GET response is shown below, in which the bulk GET response returns a work order for Worker1 and Worker2, but no work orders are available or returned for Worker3:

```
{
  “BulkGetRequestResponse”: {
    “Worker1”: {
      “id”: “Worker1”,
      “statusCode”: 200,
      “status”: “OK”,
      “workorder”: {
        “id”: “66b6af5d-6251-4752-9f42-2c2e9ea56cee”,
        “task”: “2792fba7-4398-42cb-b914-6269ae2b763d”,
        “partition”: “1”,
        “delimitationLimit”: 10,
        “delimitationSeqno”: 1,
        “source”: “HANA”,
        “target”: “HANA”,
        “type”: “TRANSFER_ORDER”,
        “status”: “PROCESSING”
      }
    },
    “Worker2”: {
      “id”: “Worker2”,
      “statusCode”: 200,
      “status”: “OK”,
      “workorder”: {
        “id”: “674f83cf-1f26-44b0-bdc5-e0e4cef00337”,
        “task”: “29f27538-862f-47eb-a467-953f7e51fd6e”,
        “partition”: “1”,
        “delimitationLimit”: 10,
        “delimitationSeqno”: 1,
        “source”: “HANA”,
        “target”: “HANA”,
          “type”: “TRANSFER_ORDER”,
      “status”: “PROCESSING”
      }
    },
    “Worker3”: {
      “id”: “Worker3”,
      “statusCode”: 404,
      “status”: “no available work order”,
      “workorder”: “”
    }
  }
}
```

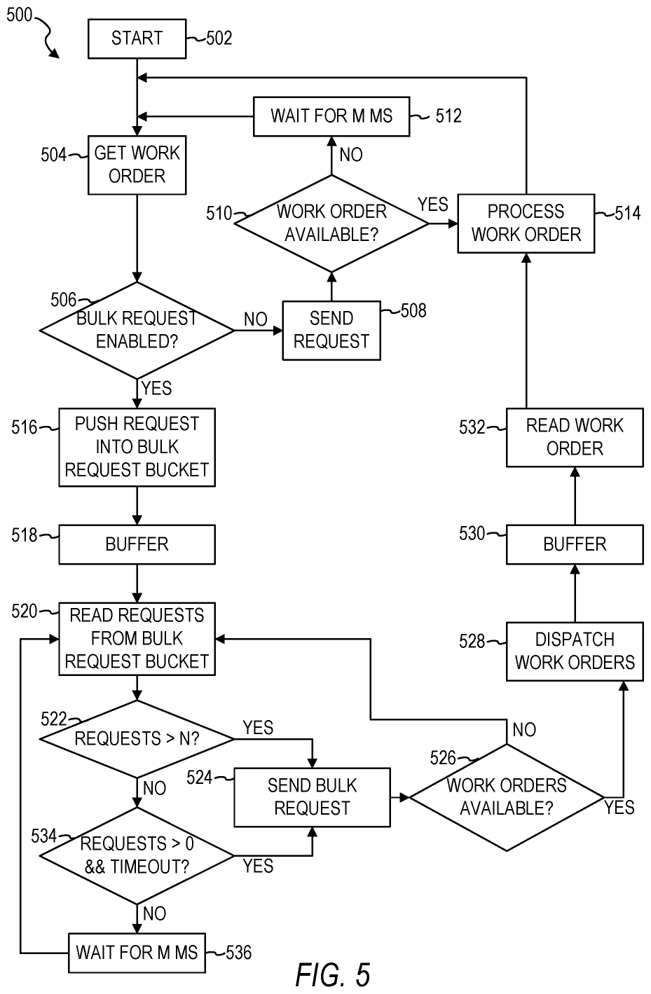

FIG. 5 is a flowchart illustrating an example method 500 of implementing a bulk GET request. The method 500 can be performed by processing logic that can comprise hardware (e.g., circuitry, dedicated logic, programmable logic, microcode, etc.), software (e.g., instructions run on a processing device), or a combination thereof. In one example embodiment, one or more of the operations of the method 500 are performed by the smart request system 200 of FIG. 2 or any combination of one or more of its components (e.g., by the pipeline service 260).

At operation 502, the smart request system 200 may start the method 500. Next, the agent worker 310 may perform a get work order process, at operation 504, in which the agent worker 310 checks to see whether bulk request mode has been enabled, such as by checking a corresponding flag that indicates whether the smart request system 200 is in single request mode or bulk request mode. If it is determined, at operation 506, that bulk request mode has not been enabled, then the agent worker 310 may send a request for a work order using the single request mode at operation 508. Then, at operation 510, the agent worker 310 may determine whether a work order is available. If a work order is available, then the agent worker 310 may process the work order, at operation 514, and then return to the get work order process, at operation 504. If a work order is not available, at operation 510, then the agent worker 310 may wait for a particular amount of time, at operation 512, before returning to the get work order process, at operation 504. For example, the agent worker 310 may wait for M milliseconds, where M is a positive integer.

If, at operation 506, the bulk request mode has been enabled, then the agent worker 310 may push a request corresponding to the work order into a request bucket, at operation 516, and the requests in the request bucket may be temporarily stored in a buffer, at operation 518. The buffer may store bulk GET request orders that contain a list of agent workers 310 that have a status indicating that they are free or otherwise available to perform tasks.

Next, at operation 520, the bulk request manager 330 may perform the bulk get work order process, fetching the request orders that are in the buffer. The bulk request manager 330 may require that the total number of request orders in the buffer satisfy a minimum threshold number before sending a bulk request for request orders fetched from the buffer. For example, at operation 522, the bulk request manager 330 may determine whether the total number of request orders in the buffer is greater than N, where N is a positive integer. Parameter N indicates the threshold to send out a bulk request. If the bulk request manager 330 determines, at operation 522, that the total number of request orders in the buffer is greater than N, then the bulk request manager 330 may, at operation 524, send the bulk request for the request orders in the buffer to a service, such as the RMS 210. The bulk request manager 330 may then determine, at operation 526 whether there are any work orders available, such as any replication tasks to be performed. If there are not any work orders available, then the bulk request manager 330 may return to operation 520, where the bulk request manager 330 may again fetch any request orders that are stored in the buffer. If it is determined, at operation 526, that there are work orders available, then the bulk request manager 330 may dispatch the work orders, at operation 528. Each work order may be stored in a buffer, at operation 530, before being read by one of the agent workers 310, at operation 532. The Agent worker 310 may then process the work order, at operation 514, and then return to the get work order process, at operation 504.

If the bulk request manager 330 determines, at operation 522, that the total number of request orders in the buffer is not greater than N, then the bulk request manager 330 may, at operation 534, determine whether the total number of request orders in the buffer is greater than zero and if a threshold amount of time has passed since reading the request orders from the buffer. If the threshold amount of time has passed, then the smart request manager 330 may proceed to operation 524, where the smart request manager 330 may send the bulk request for the request orders in the buffer to a service, such as the RMS 210, even though the total number of request orders did not satisfy the minimum threshold N at operation 522. If the threshold amount of time has not passed, at operation 534, then the bulk request manager 330 may, at operation 536, wait for a specified amount of time, such as M milliseconds, where M is a positive integer. After waiting for the specified amount of time, the bulk request manager 330 may return to operation 520, where the bulk request manager 330 may again perform the bulk get work order process, fetching the request orders that are in the buffer.

It is contemplated that any of the other features described within the present disclosure can be incorporated into the method 500.

One example of a bulk POST request to post two work order statuses for two workers within a bulk request is shown below:

```
{
  “BulkPostRequestOrder”: {
    “Worker1”: {
      “workorderstatus”: {
        “id”: “66b6af5d-6251-4752-9f42-2c2e9ea56cee”,
        “task”: “2792fba7-4398-42cb-b914-6269ae2b763d”,
        “partition”: “1”.
        “delimitationLimit”: 10,
        “delimitationSeqno”: 1,
        “source”: “HANA”,
        “target”: “HANA”,
        “type”: “TRANSFER_ORDER_STATUS”,
        “status”: “COMPLETED”
      }
    },
    “Worker2”: {
      “workorderstatus”: {
        “id”: “674f83cf-1f26-44b0-bdc5-e0e4cef00337”,
        “task”: “29f27538-862f-47eb-a467-953f7e51fd6e”,
        “partition”: “1”,
        “delimitationLimit”: 10,
        “delimitationSeqno”: 1,
        “source”: “HANA”,
        “target”: “HANA”,
        “type”: “TRANSFER_ORDER_STATUS”,
        “status”: “COMPLETED”
      }
    }
  }
}
```

One example of a bulk POST response that returns an indication as to whether each worker order status was posted successfully is shown below:

```
{
  “agentWorkersRequestResponse”: {
    “Worker1”: {
      “id”: “Worker1”,
      “statusCode”: 200,
      “status”: “OK”
    },
    “Worker2”: {
      “id”: “Worker2”.
      “statusCode”: 200,
      “status”: “OK”
    }
  }
}
```

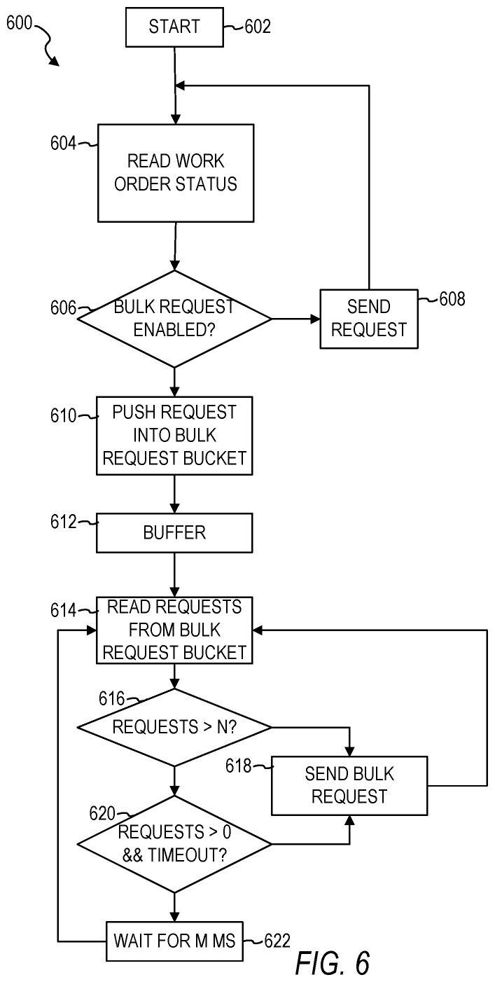

FIG. 6 is a flowchart illustrating an example method 600 of implementing a bulk POST request. The method 600 can be performed by processing logic that can comprise hardware (e.g., circuitry, dedicated logic, programmable logic, microcode, etc.), software (e.g., instructions run on a processing device), or a combination thereof. In one example embodiment, one or more of the operations of the method 600 are performed by the smart request system 200 of FIG. 2 or any combination of one or more of its components (e.g., by the pipeline service 260).

At operation 602, the smart request system 200 may start the method 600. Next, the agent worker 310 may perform a read work order status process, at operation 604, in which the agent worker 310 checks to see whether bulk request mode has been enabled, such as by checking a corresponding flag that indicates whether the smart request system 200 is in single request mode or bulk request mode. If it is determined, at operation 606, that bulk request mode has not been enabled, then the agent worker 310 may send a request to post a work order status using the single request mode at operation 608, and then return to the read work order status process, at operation 604.

If, at operation 606, the bulk request mode has been enabled, then the agent worker 310 may push a request order for the work order status that it has received into a request bucket, at operation 610, and may store the request order in a buffer, at operation 612.

Next, at operation 614, the bulk request manager 330 may perform the bulk post work order process, fetching the request orders that are in the buffer. The bulk request manager 330 may require that the total number of request orders in the buffer satisfy a minimum threshold number before sending a bulk request for request orders fetched from the buffer. For example, at operation 616, the bulk request manager 330 may determine whether the total number of request orders in the buffer is greater than N, where N is a positive integer. Parameter N indicates the threshold to send out a bulk request. If the bulk request manager 330 determines, at operation 616, that the total number of request orders in the buffer is greater than N, then the bulk request manager 330 may, at operation 618, send the bulk request for the request orders in the buffer to a service, such as the RMS 210. The bulk request manager 330 may then return to operation 614, where the bulk request manager 330 may again fetch any request orders that are stored in the buffer.

If the bulk request manager 330 determines, at operation 616, that the total number of request orders in the buffer is not greater than N, then the bulk request manager 330 may, at operation 620, determine whether the total number of request orders in the buffer is greater than zero and if a threshold amount of time has passed since reading the request orders from the buffer. If the threshold amount of time has passed, then the smart request manager 330 may proceed to operation 618, where the smart request manager 330 may send the bulk request for the request orders in the buffer to a service, such as the RMS 210, even though the total number of request orders did not satisfy the minimum threshold N at operation 616. If the threshold amount of time has not passed, at operation 620, then the bulk request manager 330 may, at operation 622, wait for a specified amount of time, such as M milliseconds, where M is a positive integer. After waiting for the specified amount of time, the bulk request manager 330 may return to operation 614, where the bulk request manager 330 may again perform the bulk get work order process, fetching the request orders that are in the buffer.

It is contemplated that any of the other features described within the present disclosure can be incorporated into the method 600.

In view of the disclosure above, various examples are set forth below. It should be noted that one or more features of an example, taken in isolation or combination, should be considered within the disclosure of this application.

Example 1 includes a computer-implemented method performed by a computer system having a memory and at least one hardware processor, the computer-implemented method comprising: obtaining, by a first service of a microservices architecture, a first set of one or more metrics of the microservices architecture, the microservices architecture including the first service, a second service, and a network, the first service and the second service being configured to communicate with each other via the network; determining, by the first service, that the first set of one or more metrics satisfies one or more bulk mode conditions; identifying, by the first service, a plurality of workers of the first service running in parallel to one another, each one of the plurality of workers being configured to execute a task; and sending, by the first service, a bulk request to the second service based on the determining that the first set of one or more metrics satisfies the one or more bulk mode conditions, the bulk request comprising a corresponding request body portion for each worker in the plurality of workers.

Example 2 includes the computer-implemented method of example 1, wherein the task comprises a data replication task.

Example 3 includes the computer-implemented method of example 1 or example 2, wherein the first set of one or more metrics comprises a total number of workers in the plurality of workers, and the one or more bulk mode conditions comprise the total number of workers being greater than a threshold number.

Example 4 includes the computer-implemented method of any one of examples 1 to 3, wherein the first set of one or more metrics comprises a central processing unit (CPU) usage value of the second service, and the one or more bulk mode conditions comprise the CPU usage value of the second service being greater than a threshold usage value.

Example 5 includes the computer-implemented method of any one of examples 1 to 4, wherein the first set of one or more metrics comprises a network latency metric of the network, and the one or more bulk mode conditions comprise the network latency metric being greater than a threshold latency value.

Example 6 includes the computer-implemented method of any one of examples 1 to 5, wherein the first set of one or more metrics comprises a bandwidth metric of the network, and the one or more bulk mode conditions comprise the bandwidth metric being less than a threshold bandwidth value.

Example 7 includes the computer-implemented method of any one of examples 1 to 6, wherein the first set of one or more metrics comprises a packet loss metric of the network, and the one or more bulk mode conditions comprise the packet loss metric being greater than a threshold packet loss value.

Example 8 includes the computer-implemented method of any one of examples 1 to 7, wherein the first set of one or more metrics comprises two or more metrics from a group of metrics consisting of a total number of workers in the plurality of workers, a central processing unit (CPU) usage value of the second service, a network latency metric of the network, a bandwidth metric of the network, and a packet loss metric of the network.

Example 9 includes the computer-implemented method of any one of examples 1 to 8, wherein the bulk request comprises a Hypertext Transfer Protocol (HTTP) request.

Example 10 includes the computer-implemented method of any one of examples 1 to 9, further comprising: obtaining, by the first service, a second set of the one or more metrics of the microservices architecture; determining, by the first service, that the second set of the one or more metrics does not satisfy the one or more bulk mode conditions; and, for each worker in the plurality of workers, sending, by the first service to the second service, a corresponding request based on the determining that the second set of one or more metrics does not satisfy the one or more bulk mode conditions.

Example 11 includes a system comprising: at least one processor; and a non-transitory computer-readable medium storing executable instructions that, when executed, cause the at least one processor to perform the method of any one of examples 1 to 10.

Example 12 includes a non-transitory machine-readable storage medium, tangibly embodying a set of instructions that, when executed by at least one processor, causes the at least one processor to perform the method of any one of examples 1 to 10.

Example 13 includes a machine-readable medium carrying a set of instructions that, when executed by at least one processor, causes the at least one processor to carry out the method of any one of examples 1 to 10.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 114 of FIG. 1) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

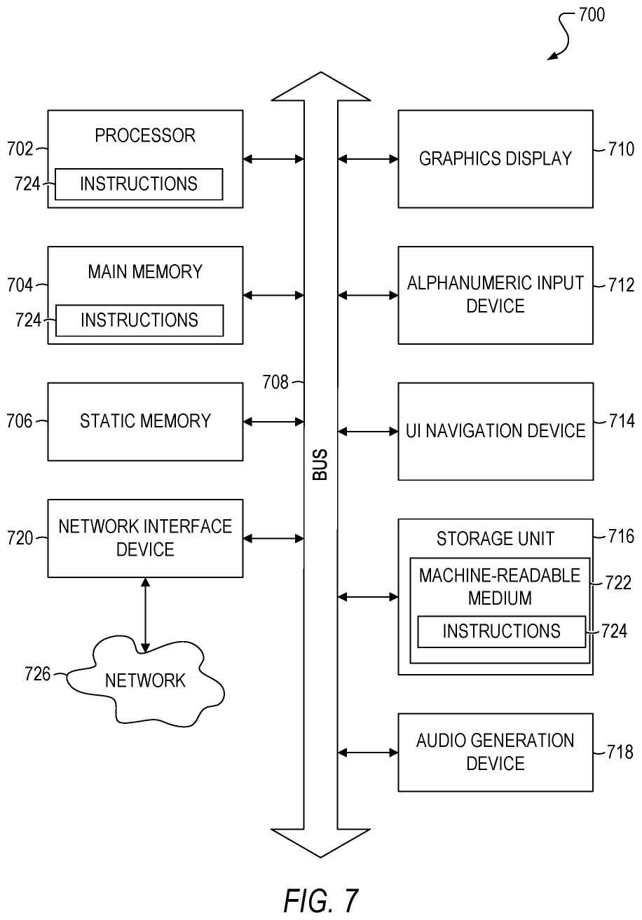

FIG. 7 is a block diagram of a machine in the example form of a computer system 700 within which instructions 724 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704, and a static memory 706, which communicate with each other via a bus 708. The computer system 700 may further include a graphics or video display unit 710 (e.g., a liquid crystal display (LCD) or a cathode ray tube (CRT)). The computer system 700 also includes an alphanumeric input device 712 (e.g., a keyboard), a user interface (UI) navigation (or cursor control) device 714 (e.g., a mouse), a storage unit (e.g., a disk drive unit) 716, an audio or signal generation device 718 (e.g., a speaker), and a network interface device 720.

The storage unit 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media. The instructions 724 may also reside, completely or at least partially, within the static memory 706.

While the machine-readable medium 722 is shown in an example embodiment to be a single medium, the term “machine-readable medium” may include a single medium or multiple media (e.g., a centralized or distributed database, and/or associated caches and servers) that store the one or more instructions 724 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a LAN, a WAN, the Internet, mobile telephone networks, POTS networks, and wireless data networks (e.g., WiFi and WiMAX networks). The term “transmission medium” shall be taken to include any intangible medium capable of storing, encoding, or carrying instructions for execution by the machine, and includes digital or analog communications signals or other intangible media to facilitate communication of such software.

This detailed description is merely intended to teach a person of skill in the art further details for practicing certain aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

Unless specifically stated otherwise, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A computer-implemented method performed by a computer system comprising a memory and at least one hardware processor, the computer-implemented method comprising:
obtaining, by a first service of a microservices architecture, a first set of one or more metrics of the microservices architecture, the microservices architecture including the first service, a second service, and a network, the first service and the second service being configured to communicate with each other via the network;
determining, by the first service, that the first set of one or more metrics satisfies one or more bulk mode conditions;
identifying, by the first service, a plurality of workers of the first service running in parallel to one another, each one of the plurality of workers being configured to execute a task; and
sending, by the first service, a bulk request to the second service based on the determining that the first set of one or more metrics satisfies the one or more bulk mode conditions, the bulk request comprising a corresponding request body portion for each worker in the plurality of workers.

2. The computer-implemented method of claim 1, wherein the task comprises a data replication task.

3. The computer-implemented method of claim 1, wherein the first set of one or more metrics comprises a total number of workers in the plurality of workers, and the one or more bulk mode conditions comprise the total number of workers being greater than a threshold number.

4. The computer-implemented method of claim 1, wherein the first set of one or more metrics comprises a central processing unit (CPU) usage value of the second service, and the one or more bulk mode conditions comprise the CPU usage value of the second service being greater than a threshold usage value.

5. The computer-implemented method of claim 1, wherein the first set of one or more metrics comprises a network latency metric of the network, and the one or more bulk mode conditions comprise the network latency metric being greater than a threshold latency value.

6. The computer-implemented method of claim 1, wherein the first set of one or more metrics comprises a bandwidth metric of the network, and the one or more bulk mode conditions comprise the bandwidth metric being less than a threshold bandwidth value.

7. The computer-implemented method of claim 1, wherein the first set of one or more metrics comprises a packet loss metric of the network, and the one or more bulk mode conditions comprise the packet loss metric being greater than a threshold packet loss value.

8. The computer-implemented method of claim 1, wherein the bulk request comprises a Hypertext Transfer Protocol (HTTP) request.

9. The computer-implemented method of claim 1, further comprising:
obtaining, by the first service, a second set of the one or more metrics of the microservices architecture;
determining, by the first service, that the second set of the one or more metrics does not satisfy the one or more bulk mode conditions; and
for each worker in the plurality of workers, sending, by the first service to the second service, a corresponding request based on the determining that the second set of one or more metrics does not satisfy the one or more bulk mode conditions.

10. A system of comprising:
at least one hardware processor; and
a non-transitory computer-readable medium storing executable instructions that, when executed, cause the at least one hardware processor to perform computer operations comprising:
obtaining, by a first service of a microservices architecture, a first set of one or more metrics of the microservices architecture, the microservices architecture including the first service, a second service, and a network, the first service and the second service being configured to communicate with each other via the network;
determining, by the first service, that the first set of one or more metrics satisfies one or more bulk mode conditions;
identifying, by the first service, a plurality of workers of the first service running in parallel to one another, each one of the plurality of workers being configured to execute a task; and
sending, by the first service, a bulk request to the second service based on the determining that the first set of one or more metrics satisfies the one or more bulk mode conditions, the bulk request comprising a corresponding request body portion for each worker in the plurality of workers.

11. The system of claim 10, wherein the task comprises a data replication task.

12. The system of claim 10, wherein the first set of one or more metrics comprises a total number of workers running in the plurality of workers, and the one or more bulk mode conditions comprise the total number of workers being greater than a threshold number.

13. The system of claim 10, wherein the first set of one or more metrics comprises a central processing unit (CPU) usage value of the second service, and the one or more bulk mode conditions comprise the CPU usage value of the second service being greater than a threshold usage value.

14. The system of claim 10, wherein the first set of one or more metrics comprises a network latency metric of the network, and the one or more bulk mode conditions comprise the network latency metric being greater than a threshold latency value.

15. The system of claim 10, wherein the first set of one or more metrics comprises a bandwidth metric of the network, and the one or more bulk mode conditions comprise the bandwidth metric being less than a threshold bandwidth value.

16. The system of claim 10, wherein the first set of one or more metrics comprises a packet loss metric of the network, and the one or more bulk mode conditions comprise the packet loss metric being greater than a threshold packet loss value.

17. The system of claim 10, wherein the computer operations further comprise:
obtaining, by the first service, a second set of the one or more metrics of the microservices architecture;
determining, by the first service, that the second set of the one or more metrics does not satisfy the one or more bulk mode conditions; and
for each worker in the plurality of workers, sending, by the first service to the second service, a corresponding request based on the determining that the second set of one or more metrics does not satisfy the one or more bulk mode conditions.

18. A non-transitory machine-readable storage medium tangibly embodying a set of instructions that, when executed by at least one hardware processor, causes the at least one processor to perform computer operations comprising:
obtaining, by a first service of a microservices architecture, a first set of one or more metrics of the microservices architecture, the microservices architecture including the first service, a second service, and a network, the first service and the second service being configured to communicate with each other via the network;
determining, by the first service, that the first set of one or more metrics satisfies one or more bulk mode conditions; and
identifying, by the first service, a plurality of workers of the first service running in parallel to one another, each one of the plurality of workers being configured to execute a task; and
sending, by the first service, a bulk request to the second service based on the determining that the first set of one or more metrics satisfies the one or more bulk mode conditions, the bulk request comprising a corresponding request body portion for each worker in the plurality of workers.

19. The non-transitory machine-readable storage medium of claim 18, wherein the task comprises a data replication task.

20. The non-transitory machine-readable storage medium of claim 18, wherein the first set of one or more metrics comprises two or more metrics from a group of metrics consisting of a total number of workers in the plurality of workers, a central processing unit (CPU) usage value of the second service, a network latency metric of the network, a bandwidth metric of the network, and a packet loss metric of the network.
